(19) United States
(12) Patent Application Publication
(10) Pub. No.: US 2009/0135214 A1
(43) Pub. Date: May 28, 2009

(54) RASTER DATA CREATION DEVICE, COMPUTER-READABLE MEDIUM STORING RASTER DATA CREATION PROGRAM, AND DISPLAY DEVICE

(75) Inventor: Hiroaki SUZUKI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/277,816

(22) Filed: Nov. 25, 2008

(30) Foreign Application Priority Data
Nov. 26, 2007 (JP) 2007-304107

(51) Int. Cl. G09G 3/00

(52) U.S. Cl. 345/698

(57) ABSTRACT

A raster data creation device that creates raster data for displaying content includes an electronic data acquisition unit that acquires electronic data of content to be displayed on a display unit provided on a front face of a display device, a resolution storage unit that stores a first resolution computed based on a first number of pixels and an output size of the electronic data, a reference coordinates storage unit that stores reference coordinates, and a first creation unit that creates a first raster data from the electronic data acquired by the electronic data acquisition unit at the first resolution stored in the resolution storage unit based on the reference coordinates and on a second number of pixels disposed in the display-capable area.

### CROSS REFERENCE TO RELATED APPLICATION

This application claims priority to Japanese Patent Application No. JP 2007-304107, filed Nov. 26, 2007, the disclosure of which is hereby incorporated by reference in its entirety.

### BACKGROUND OF THE INVENTION

1. Field of the Invention

The present disclosure relates to a raster data creation device, a computer-readable medium storing a raster data creation program, and a display device. More specifically, the present disclosure relates to a raster data creation device and a computer-readable medium storing a raster data creation program, which create raster data that is easy for a user to view when the raster data is displayed on the display device.

2. Description of Related Art

Various types of information (i.e., content) are imported to and viewed on a display device that is provided with a screen. Accordingly, various devices have been created for making the content that is displayed on the screen of the display device easier for the user to view. For example, in an electronic book device described in Japanese Laid-Open Patent Publication No. 2002-197088, book data is displayed on the screen in such a way that the text of the book data is delimited by line breaks, commas, periods, and parentheses, for example, to make the text easier for the user to read. The content that may be displayed on this sort of portable display device is provided with a margin surrounding the area in which the content (text and/or an image) is displayed to make the content easier for the user to read. The area in which the content is displayed is hereinafter referred to as the “content display area” For example, when content that was created on a personal computer (hereinafter referred to as a “PC”) is displayed, it is assumed that the content that was created on the PC will be printed on paper, so page management is performed and margins are provided at the top, bottom, left and right sides of the page.

### SUMMARY OF THE INVENTION

The screen in the display device is held by a housing, such that the user who is viewing the screen may perceive the portion of the housing on the (front) face, on which the screen is provided, as well as the portion of the screen where the information is not displayed, as being the margin that surrounds the content display area The portion of the housing on the (front) face is hereinafter referred to as the “bezel area” If the content is displayed on the screen in a state in which the margin that surrounds the content display area is provided, the bezel area and the provided margin become double margins. Accordingly, when the entire area of the front face of the display device is taken into account, a problem may arise in that the margin area is excessive, making the user feel that the screen is hard to view.

Various exemplary embodiments of the broad principles derived herein provide a raster data creation device, a computer-readable medium that stores a raster data creation program, and a display device that create raster data that is easy for a user to view and that, when content is displayed on the display device, makes the content appear to be printed on the front face of the display device.

Exemplary embodiments provide a raster data creation device that creates raster data for displaying content The raster data creation device includes an electronic data acquisition unit that acquires electronic data of content to be displayed on a display unit provided on a front face of a display device, a resolution storage unit that stores a first resolution computed based on a first number of pixels and an output size of the electronic data, the first number of pixels being disposed in a virtual area at a pixel density of a display-capable area, the display-capable area being an area capable of displaying the electronic data in the display unit, the virtual area being determined based on the display-capable area and on an area of the front face of the display device, a reference coordinates storage unit that stores reference coordinates, the reference coordinates being set within the virtual area and corresponding to a reference point set within the display-capable area, and a first creation unit that creates a first raster data from the electronic data acquired by the electronic data acquisition unit at the first resolution stored in the resolution storage unit based on the reference coordinates and on a second number of pixels disposed in the display-capable area, the first raster data being raster data of a portion within the virtual area and corresponding to the display-capable area.

Exemplary embodiments provide a computer-readable medium storing a raster data creation program that creates raster data for displaying content. The program causes a controller to perform the steps of acquiring electronic data of content to be displayed on a display unit provided on a front face of a display device, and creating a first raster data from the electronic data acquired in the acquiring step at a first resolution, based on reference coordinates and on a first number of pixels disposed in a display-capable area, the display-capable area being an area capable of displaying the electronic data in the display unit, the first raster data being raster data of a portion being within a virtual area and corresponding to the display-capable area, the first resolution being computed based on a second number of pixels and on an output size of the electronic data and stored in advance, the virtual area being determined based on the display-capable area and on an area of the front face of the display device, the reference coordinates being coordinates set within the virtual area and corresponding to a reference point set within the display-capable area, the second number of pixels being disposed in the virtual area at a pixel density of the display-capable area

Exemplary embodiments provide a display device that includes a raster data creation device that creates raster data for displaying content The raster data creation device includes an electronic data acquisition unit that acquires electronic data of content to be displayed on a display unit provided on a front face of a display device, a resolution storage unit that stores a first resolution computed based on a first number of pixels and an output size of the electronic data, the first number of pixels being disposed in a virtual area at a pixel density of a display-capable area, the display-capable area being an area capable of displaying the electronic data in the display unit, the virtual area being determined based on the display-capable area and on an area of the front face of the display device, a reference coordinates storage unit that stores reference coordinates, the reference coordinates being set within the virtual area and corresponding to a reference point set within the display-capable area, and a first creation unit that creates a first raster data from the electronic data acquired by the electronic data acquisition unit at the first resolution stored in the resolution storage unit based on the reference coordinates and on a second number of pixels disposed in the display-capable area, the first raster data being raster data of a portion within the virtual area and corresponding to the display-capable area

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

Exemplary embodiments are described below in detail with reference to the accompanying drawings.

FIG. 1 is a front view of a display device.

FIG. 2 is a schematic diagram that shows a display-capable area and a non-display-capable area of the display device.

FIG. 3 is a block diagram that shows a hardware configuration of the display device.

FIG. 4 is a block diagram that shows a hardware configuration of a PC.

FIG. 5 is a schematic diagram that shows a display device driver storage area that is provided in a hard disk device in the PC.

FIG. 6 is a schematic diagram that shows a flow of raster data creation in the PC.

FIG. 7 is a schematic diagram that shows a page layout in normal output.

FIG. 8 is a schematic diagram that shows a state in which content is displayed by the normal output

FIG. 9 is a schematic diagram that shows a virtual area when content is displayed by bezel-compatible output;

FIG. 10 is a schematic diagram that shows a state in which the content is displayed by the bezel-compatible output.

FIG. 11 is a schematic diagram that shows names of lengths of various portions of a front face of the display device.

FIG. 12 is a schematic diagram of a front face of a display device with a lower bezel area that has an elongated vertical dimension.

FIG. 13 is a schematic diagram that shows a virtual area when content is displayed by the bezel-compatible output on the display device with the lower bezel area that has the elongated vertical dimension.

FIG. 14 is a schematic diagram of a front face of a display device with a wide bezel area.

FIG. 15 is a schematic diagram that shows a virtual area when content is displayed by the bezel-compatible output on the display device with the wide bezel area.

FIG. 16 is a schematic diagram of a front face of a display device with a narrow bezel area.

FIG. 17 is a schematic diagram that shows a state in which the content is displayed by the bezel-compatible output on the display device with the narrow bezel area.

FIG. 18 is a schematic diagram that shows a virtual area when content is displayed by the bezel-compatible output on the display device with the narrow bezel area.

FIG. 19 is a schematic diagram of a front face of a display device in which an indicator portion is provided in a display panel.

FIG. 20 is a schematic diagram that shows a virtual area when content is displayed by the bezel-compatible output on the display device in which the indicator portion is provided in the display panel.

FIG. 21 is a flowchart of processing that is performed when a display driver program receives an output command.

### DETAILED DESCRIPTION OF EXEMPLARY EMBODIMENTS

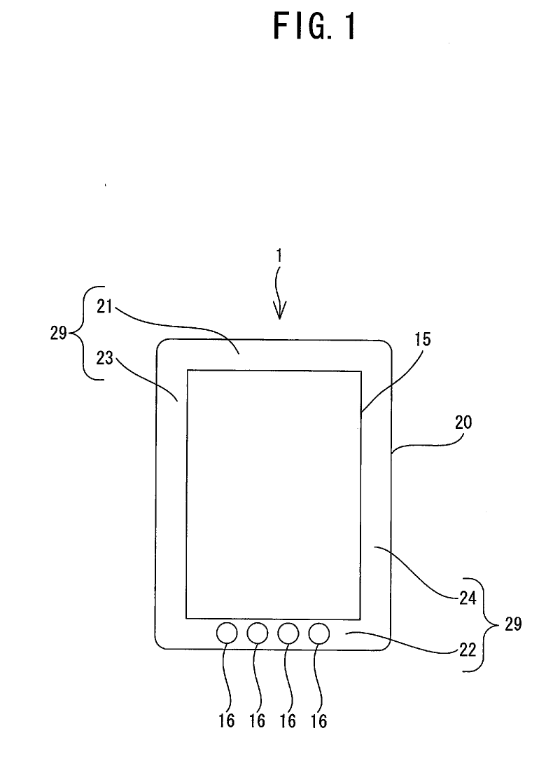

Exemplary embodiments of the present disclosure now are explained with reference to the accompanying drawings. A display device 1 is explained with reference to FIGS. 1 to 3.

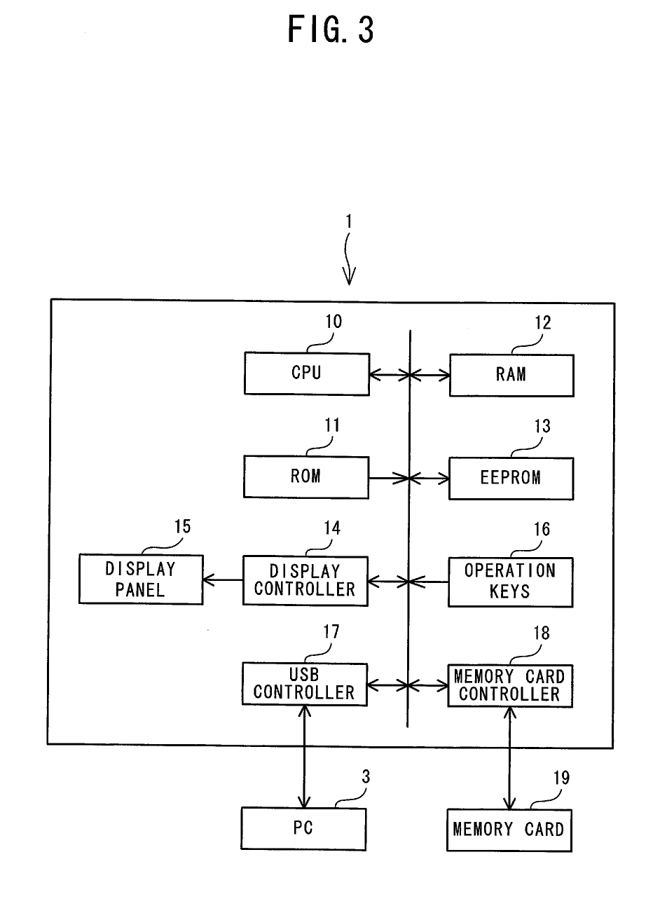

As shown in FIG. 1, a display panel 15 is provided on a front face of the display device 1. A plurality of pixels may be arrayed in a grid pattern on the display panel 15. An output command and a no-output command are given to the individual pixels by a CPU 10 (depicted in FIG. 3). Various types of information may be displayed on the entire display panel 15. The display panel 15 is fitted within a substantially rectangular housing 20. In FIG. 1, a top-to-bottom direction of a page space is referred to as a vertical direction, and a left-to-right direction of the page space is referred to as a horizontal direction. On the front face of the display device 1, an area that is occupied by the housing 20 is referred to as a bezel area 29. In the example shown in FIG. 1, a portion that surrounds the display panel 15 serves as the bezel area 29. Within the bezel area 29, the area above the display panel 15 is referred to as a top bezel area 21, the area below the display panel 15 is referred to as a bottom bezel area 22, the area to the left of the display panel 15 is referred to as a left bezel area 23, and the area to the right of the display panel 15 is referred to as a right bezel area 24. Four operation keys 16 are provided in the bottom bezel area 22.

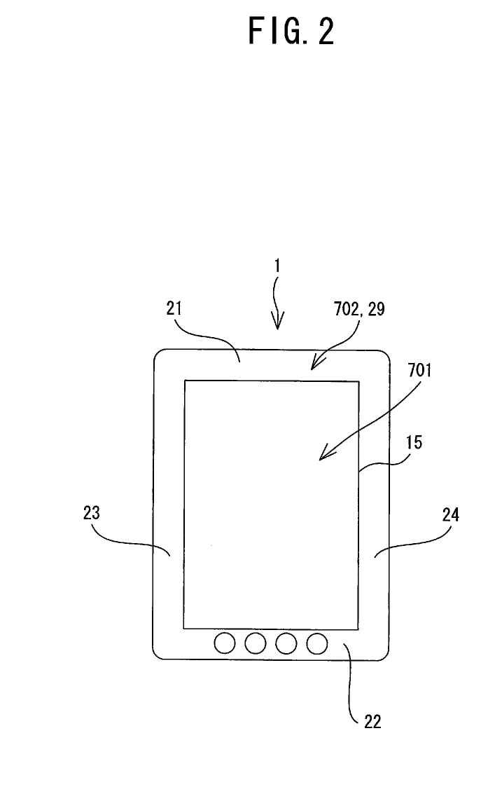

In the display device 1, content may be displayed in the entire area of the display panel 15. Accordingly, as shown in FIG. 2, the entire area of the display panel 15 is a display-capable area 701. The bezel area 29 is a non-display-capable area 702. The dimensions of the display-capable area 701 of the display device 1 and the front face of the display device 1 have the same aspect ratio as an aspect ratio that is prescribed in the Japanese Industrial Standards (JIS) for A-series paper sizes. The display-capable area 701 is the area in which content may be displayed. The non-display-capable area 702 is the area on the front face of the display device 1 in which content is not displayed

A hardware configuration of the display device 1 is explained with reference to FIG. 3. As shown in FIG. 3, the display device 1 comprises the CPU 10. A ROM 11, a RAM 12, an EEPROM 13, a display controller 14, the operation keys 16, a USB controller 17, and a memory card controller 18 are connected to the CPU 10 via a bus. The CPU 10 controls the display device 1. The ROM 11 stores a display program for operating the display device 1, and the like. The RAM 12 temporarily stores various types of data The EEPROM 13 stores various types of information. The display controller 14 controls the display panel 15. The operation keys 16 are configured to accept an input entered by a user. The USB controller 17 is configured to be connected to a PC 3. The memory card controller 18 is configured to be connected to a memory card 19. The display device 1 displays text and/or an image on the display panel 15 in accordance with an output command from the PC 3. The display device 1 may display on the display panel 15 content that is stored in the memory card 19. The content may be information that is created by various types of applications. The content may be stored in the memory card 19 in a form of an electronic data file in a format that is defined by each of the applications.

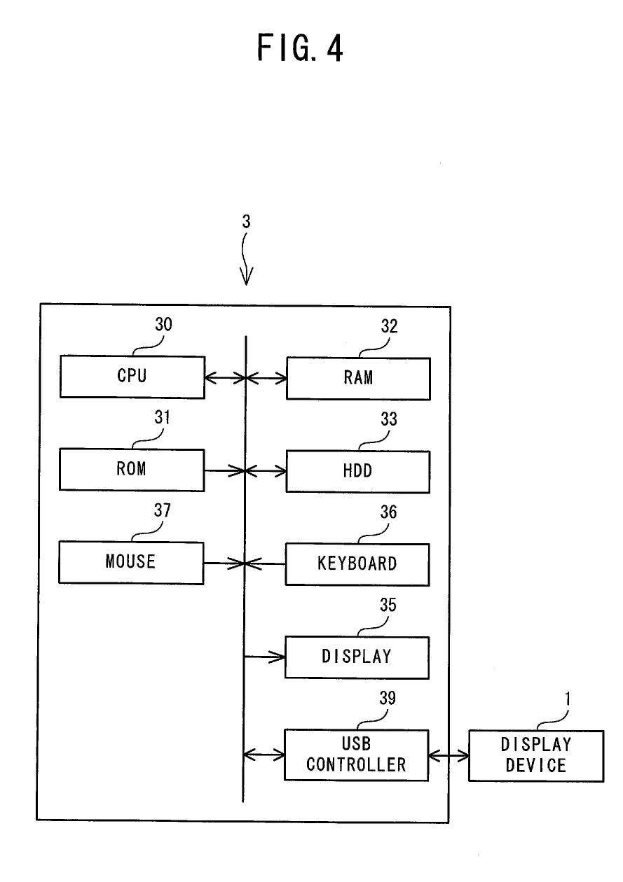

The PC 3 is described with reference to FIGS. 4 to 6. As shown in FIG. 4, the PC 3 comprises a CPU 30. A ROM 31, a RAM 32, a hard disk device (HDD) 33, a keyboard 36, a mouse 37, a display 35, and a USB controller 39 are connected to the CPU 30 via a bus. The CPU 30 controls the PC 3. The ROM 31 stores a BIOS and the like. The RAM 32 temporarily stores various types of data. The HDD 33 stores an operating system (OS), a program, and various types of information. The keyboard 36 and the mouse 37 are each configured to accept an input entered by the user. The display 35 outputs text and/or an image. The USB controller 39 is configured to be connected to the display device 1.

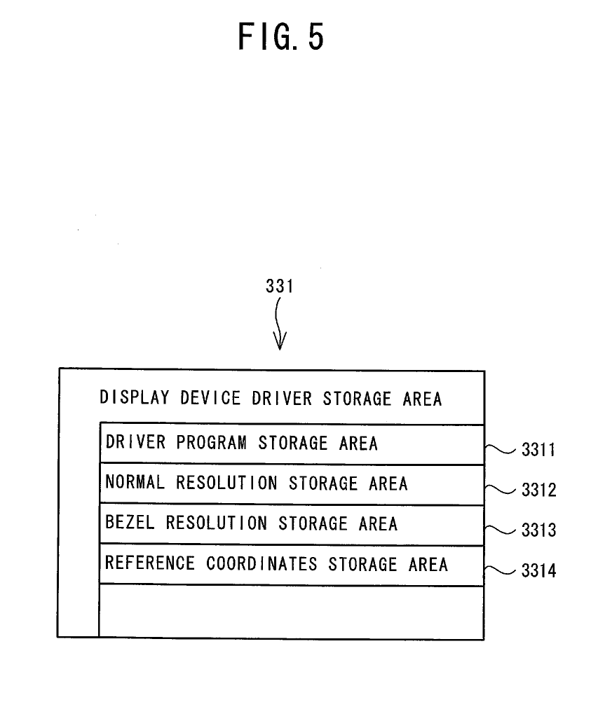

The HDD 33 comprises a display device driver storage area 331 shown in FIG. 5. The display device driver storage area 331 stores a display device driver that sends an output command to the display device 1 when an output command is issued from an application to the display device 1. As shown in FIG. 5, the display device driver storage area 331 comprises a driver program storage area 3311, a normal resolution storage area 3312, a bezel resolution storage area 3313, and a reference coordinates storage area 3314. The driver program storage area 3311 stores a display driver program that serves as the display device driver and operates the PC 3. The normal resolution storage area 3312 stores a resolution to be used for normal output for each page size (for example, A4, B5, A5). In normal output, one page of content is displayed in the display-capable area 701 of the display panel 15. The bezel resolution storage area 3313 stores a resolution to be used for bezel-compatible output for each page size. In bezel-compatible output, one page of the content is disposed in a virtual area (described in detail below), which is defined based on both the display-capable area 701 of the display panel 15 and the non-display-capable area 702 (e.g., the bezel area 29). The reference coordinates storage area 3314 stores reference coordinates (described in detail below) for bezel-compatible output.

The display device driver is created for each type of a display device. When a plurality of types of display devices may be connected to the PC 3, the HDD 33 stores a plurality of display device drivers each corresponding to each type of the display devices. The HDD 33 also stores data files of contents.

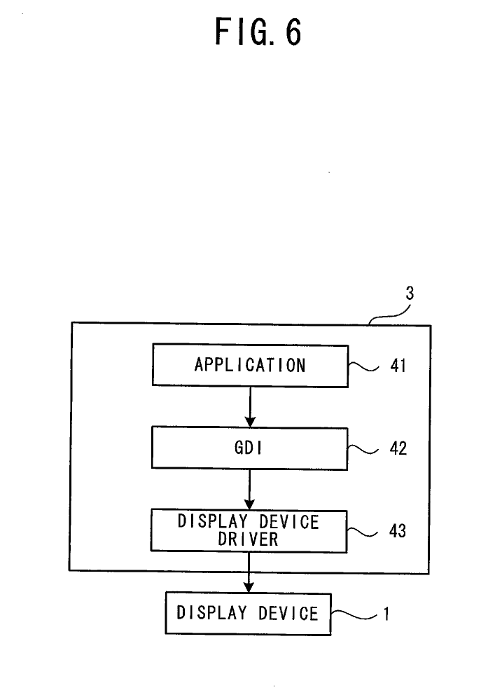

A flow of raster data creation in the PC 3 will be explained with reference to FIG. 6. First, the content output command is output from an application 41 to a graphic device interface (GDI) 42. The application 41 may be any application that creates visible data in response to a command from the user, such as a word processing application, a spreadsheet application, and an image drawing application. The output command is output in response to a command from the user. The command from the user may be executed by selecting a menu called “output to display device” that is provided with the application. The command from the user also may be executed by selecting the display device 1, not a printer, from a “print” menu. When the user executes the output command, the user designates one of normal output and bezel-compatible output in order to designate a raster data creation method. An “output to display device by normal output” menu and an “output to display device by bezel-compatible output” menu may be provided in order to make it possible for the user to designate one of normal output and bezel-compatible output When the “output to display device” is selected, a screen may be displayed that shows an input item (for example, a list box, a radio button) that allows the user to select the type of output and provides the user with commands for making the selection The display device driver storage area 331 also may comprise a creation method storage area that stores a value that indicates which of the two methods, normal output and bezel-compatible output, is used to create the raster data The value may be selected on a display device driver setting screen and stored. In the explanation below, a data file that is created by a word processing application will be used as an example, but the present disclosure is not limited to this example.

The output command includes various types of information on the content that is output to the display device 1 to be displayed on the display panel 15, such as text data for the content, a page size, a creation method (normal output/bezel-compatible output), page margins, character spacing, and line spacing. The GDI 42 that receives the output command from the application 41 outputs the output command to a display device driver 43 for the display device 1 that is designated as the output destination. The raster data to be displayed on the display panel 15 of the display device 1 is created in accordance with the display device driver 43 based on the output command. The created raster data is transmitted to the display device 1 and displayed on the display panel 15 of the display device 1.

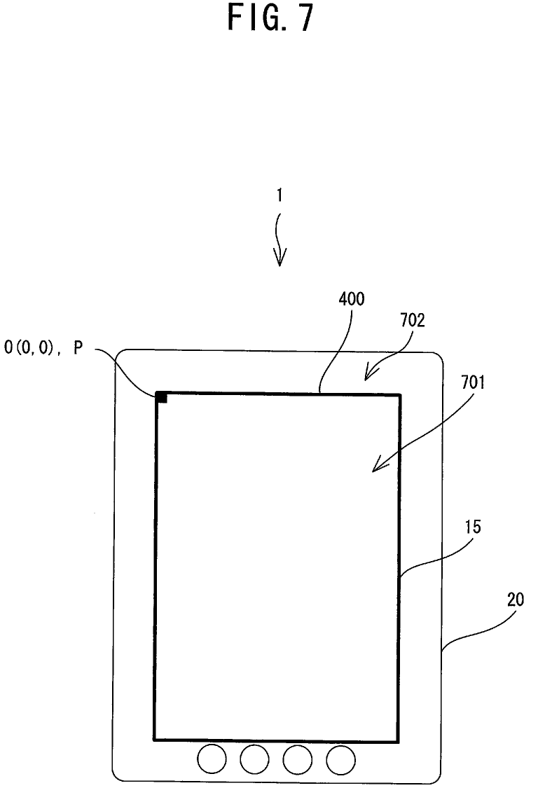

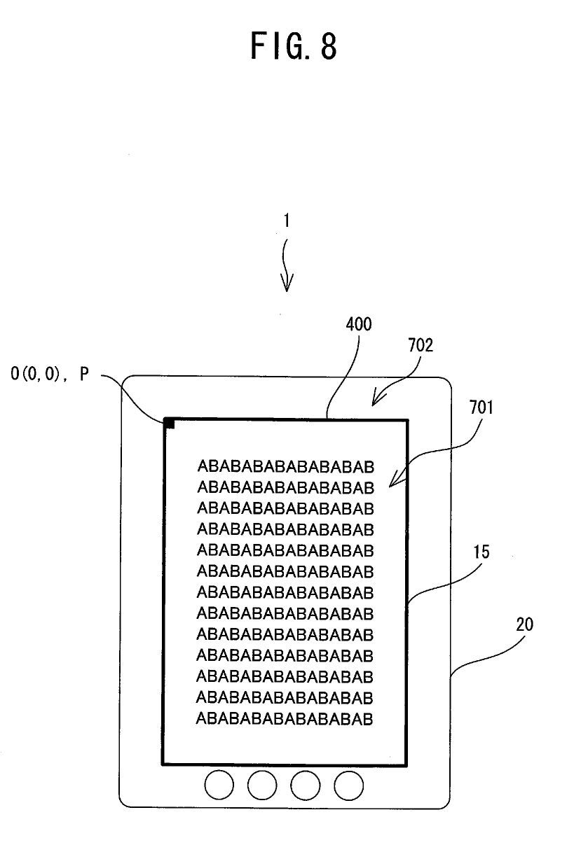

Normal output is explained with reference to FIGS. 7 and 8. A bold frame 400 shown in FIG. 7 indicates the outline of an A-series page. A pixel P indicates the pixel in the upper left corner of the display panel 15. The pixel P is a pixel that serves as a reference point. An origin point O indicates a point at the upper left corner of the page. The CPU 10 creates the raster data with a resolution that allows the display of the content at the maximum size on the display panel 15. The page origin point O of the created raster data is positioned at the pixel P, which is the reference point on the display panel 15. Because the aspect ratio of the display panel 15 of the display device 1 is the same as the aspect ratio of the A-series paper sizes, the perimeter of the display-capable area 701 coincides with the bold frame 400 as shown in FIG. 7.

According to normal output as shown in FIG. 7, content may be displayed as shown in FIG 8. In FIG. 8, the text “ABABAB . . . ” is the displayed content The margins are set for the page in the data file of the content. Accordingly, the text is displayed inside the bold frame 400 such that the text is separated from the bold frame 400 by the amounts of the set margins. Thus, if the entire area of the front face of the display device 1 is viewed, when normal output is used, not only the margin area that is set within the display-capable area 701 in the data file, but also the non-display-capable area 702 may be perceived as the margin.

A method of determining the resolution for normal output now is explained. The resolution for normal output is determined by the page size and by the number of pixels in the display-capable area 701. The display panel 15 is configured from 826 pixels horizontally and 1169 pixels vertically. The page size in the data file is A4 (0.21 m wide, 0.297 m high), for example. In this case, the resolution is obtained as 826 pixels/(0.21×39.37)≈100. 39.37 is a coefficient for converting meters to inches. Thus the normal resolution for the A4 page size is 100 dpi. This value is computed by the manufacturer and is factory-set for the display device driver. When the display device driver is installed in the PC 3, the value is stored in the normal resolution storage area 3312. In the case of normal output, the page origin point O is positioned at the reference point P of the display panel 15, so that the CPU 10 creates the raster data for 826 pixels horizontally by 1169 pixels vertically from the page origin point O (0,0) of the raster data

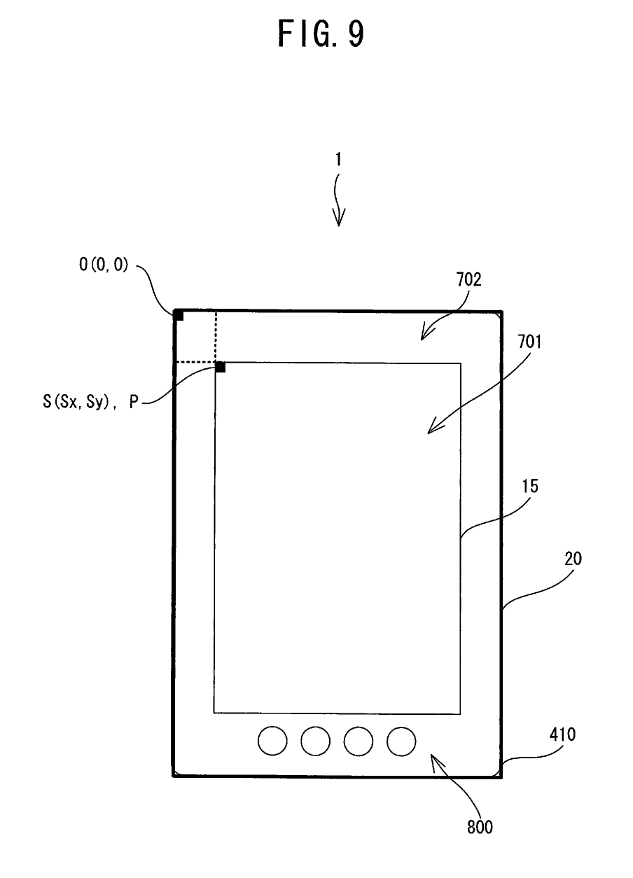

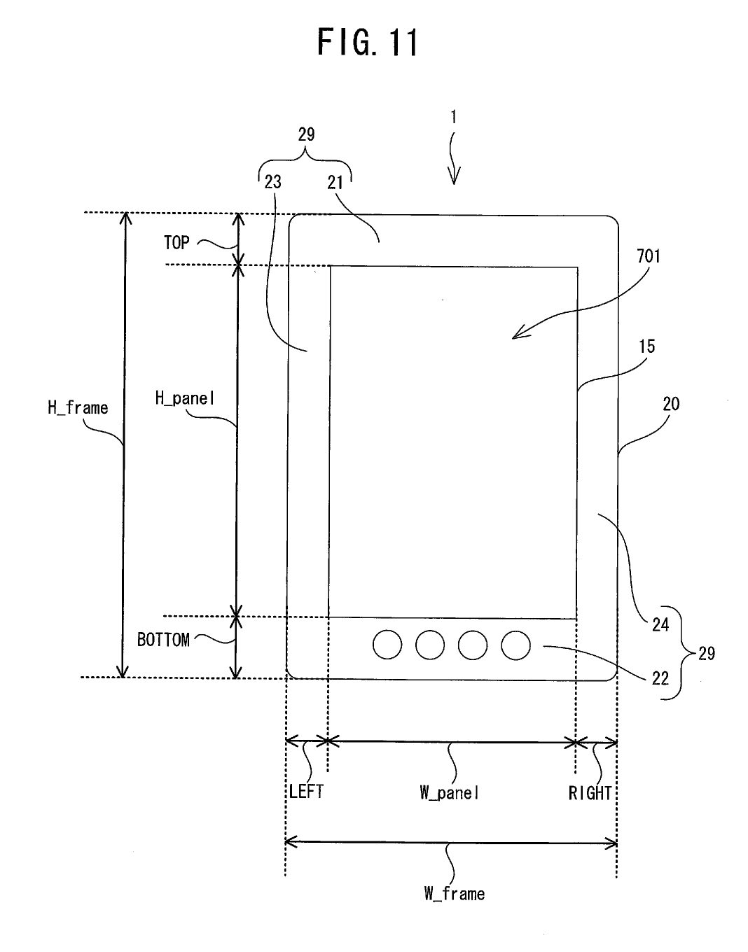

Bezel-compatible output is explained with reference to FIGS. 9 to 11. For bezel-compatible output, a virtual area 800 is posited, taking the entire front face of the display device 1 into account. The perimeter of an area that may be obtained by enlarging the display-capable area 701 is a bold frame 410, shown in FIG. 9. The area within the bold frame 410 is defined as the virtual area 800. The rate of the enlargement may be determined based on the size of the display-capable area 701 and on the size of the display device 1. The resolution for bezel-compatible output may be determined based on the rate of the enlargement. A method of determining the rate of the enlargement and the resolution is explained below with reference to FIG. 11. The aspect ratio of the front face of the display device 1 is the same as the aspect ratio of the A-series page sizes, so that the bold frame 410 coincides with the perimeter of the front face of the display device 1.

The page is disposed, such that the page origin point O (0,0) of the raster data is positioned in the upper left corner of the virtual area 800. In the same manner as in FIG. 7, the pixel P indicates the pixel in the upper left corner of the display panel 15. The pixel P is a pixel that serves as the reference point The point in the virtual area 800 that corresponds to the reference point P is a starting point S. In bezel-compatible output, the raster data for the page is created only for a portion that corresponds to the portion of the virtual area 800 that overlaps the display-capable area 701. The portion that overlaps the display-capable area 701 may be determined according to the starting point S and the size of the display panel 15 (826 pixels wide, 1169 pixels high). Specifically, the portion of the virtual area 800 that overlaps the display-capable area 701 is a rectangular area that is defined by two sides, one of which extends 826 pixels to the right from the coordinates of the starting point S and the other of which extends 1169 pixels downward from the coordinates of the starting point S. A method of computing the coordinates of the starting point S is explained below with reference to FIG. 11.

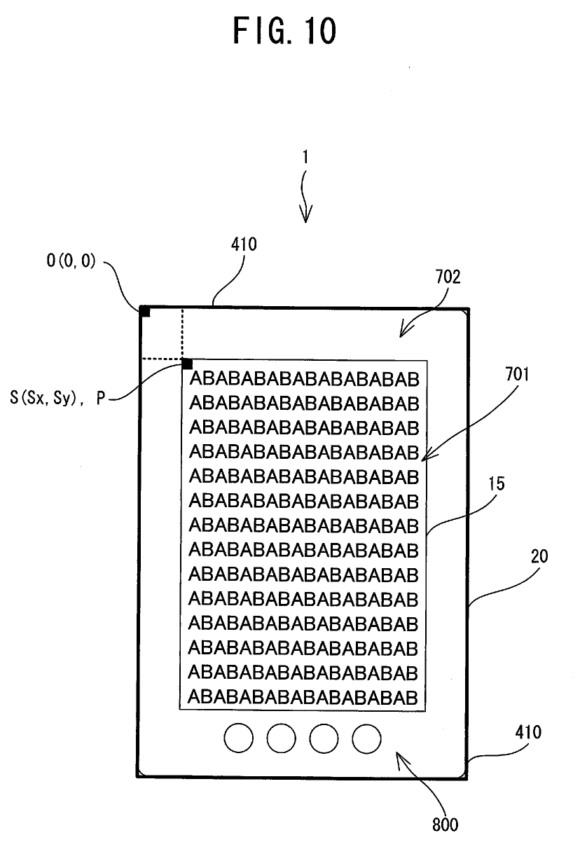

According to bezel-compatible output as shown in FIG. 9, the content is displayed as shown in FIG. 10. In this case, the text “ABABAB . . . ” is the displayed content The margins are set for the page in the data file of the content However, the greater part of the margin area corresponds to the non-display-capable area 702, such that the bezel area 29 (refer to FIG. 1) may look like a part of the margin. Thus the entire front face of the display device 1 is made to look like a paper page on which the content is printed.

The methods of determining the resolution and the starting point S for bezel-compatible output is explained with reference to FIG. 11. As shown in FIG. 11, the vertical length (height) of the front face of the display device 1 is called H frame, and the horizontal length (width) is called W_frame. The vertical length (height) of the display-capable area 701 of the display panel 15 is called H_panel, and the horizontal length (width) is called W_panel. The vertical length of the top bezel area 21 (the shortest distance from the top edge of the display panel 15 to the top edge of the housing 20) is called TOP, and the vertical length of the bottom bezel area 22 (the shortest distance from the bottom edge of the display panel 15 to the bottom edge of the housing 20) is called BOTTOM. The horizontal length of the left bezel area 23 (the shortest distance from the left edge of the display panel 15 to the left edge of the housing 20) is called LEFT, and the horizontal length of the right bezel area 24 (the shortest distance from the right edge of the display panel 15 to the right edge of the housing 20) is called RIGHT. LEFT, RIGHT, TOP, and BOTTOM are called the widths of the bezel area 29. The equations: H_frame=(H_panel)+(TOP)+(BOTTOM) and W_frame=(W_panel)+(LEFT)+(RIGHT) hold true. The number of pixels in the display-capable area 701 is expressed by the equation: (number of pixels horizontally, number of pixels vertically)=(X_res, Y_res). The page size is expressed by the equation: (horizontal size, vertical size)=(W_page, H_page).

The ratio (bezel_ratio) of the horizontal length (W_frame) of the front face of the display device 1 to the width (W_panel) of the display-capable area 701 is computed by the equation: bezel_ratio=(W_frame)/(W_panel). Bezel_ratio is employed as the rate of enlargement of the display-capable area 701. Further, the number of pixels horizontally in the virtual area 800 is computed by multiplying bezel_ratio by X_res, the number of pixels horizontally in the display-capable area 701. That is, the number of pixels horizontally in the virtual area 800 is obtained as (X_res)×(bezel_ratio). The resolution is computed by dividing the computed value by (W_page)×39.37. Therefore, if the resolution for bezel-compatible output is expressed as DPI, an equation: DPI={(X_res)×(bezel_ratio)}/{(W_page)×39.37} holds true.

The method of computing the coordinates (Sx, Sy) of the starting point S is explained. Sx is the coordinate in the horizontal dimension, and Sy is the coordinate in the vertical dimension. The horizontal length (LEFT) of the left bezel area 23 is used to compute Sx. The horizontal coordinate (Sx) of the starting point S is the number of pixels that corresponds to the width of the left bezel area 23. Sx is computed by multiplying the ratio of LEFT to the horizontal length (W_frame) of the front face of the display device 1 by the number of pixels horizontally in the virtual area 800. That is, Sx is obtained as {(X_res)×(bezel_ratio)}×{(left)/(W_frame)}. In the same manner, the vertical length (TOP) of the top bezel area 21 is used to compute Sy. The vertical coordinate (Sy) of the starting point S is the number of pixels that corresponds to the width of the top bezel area 21. Sy is computed by multiplying the ratio of TOP to the vertical length (H_frame) of the front face of the display device 1 by the number of pixels vertically in the virtual area 800. That is, Sy is obtained as {(Y_res)×(bezel_ratio)}×{(TOP)/(H_frame)}.

The resolution and the coordinates (reference coordinates) of the starting point S for bezel-compatible output may be determined as described above. The resolution and the coordinates of the starting point S for bezel-compatible output are computed by the manufacturer and are factory-set for the display device driver. When the display device driver is installed in the PC 3, the resolution and the coordinates of the starting point S for bezel-compatible output are stored in the bezel resolution storage area 3313 and the reference coordinates storage area 3314, respectively. In the present embodiment, the horizontal direction serves as the reference, and the display-capable area 701 is enlarged until the width of the display-capable area 701 matches the horizontal width of the front face of the display device 1. Nevertheless, the vertical direction may also serve as the reference, and the display-capable area 701 may be enlarged until the height of the display-capable area 701 matches the height of the front face. In that case, the equation bezel_ratio=(H_frame)/(H_panel) may be used.

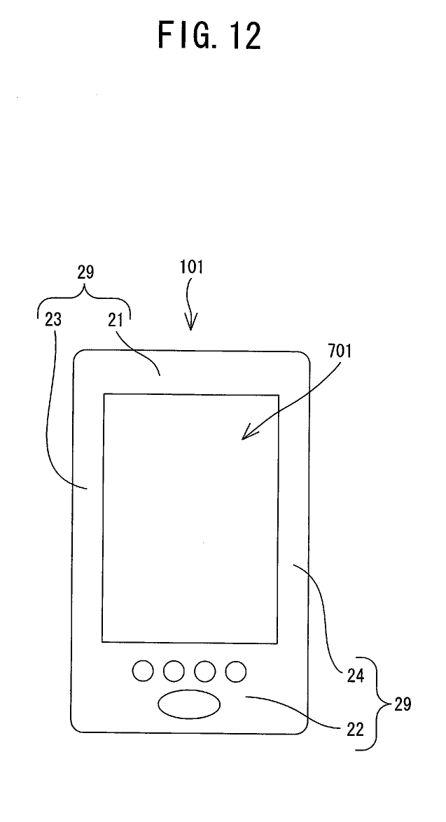

A modified example of the computation of the resolution and the reference coordinates for bezel-compatible output is explained with reference to FIGS. 12 to 20.

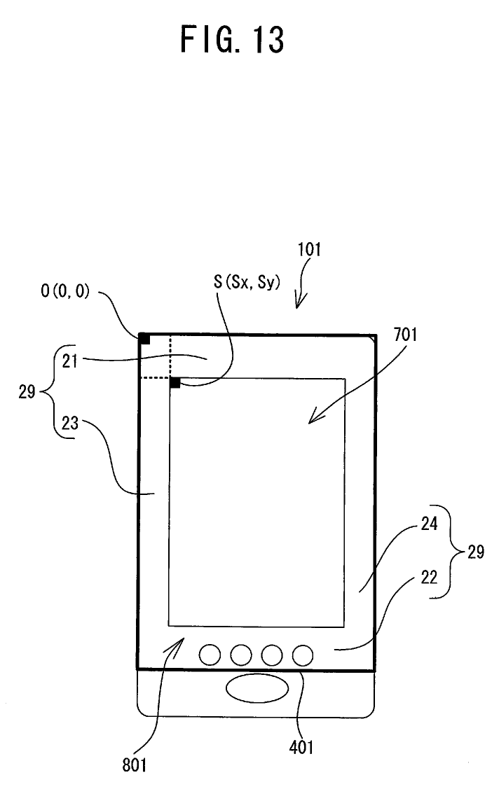

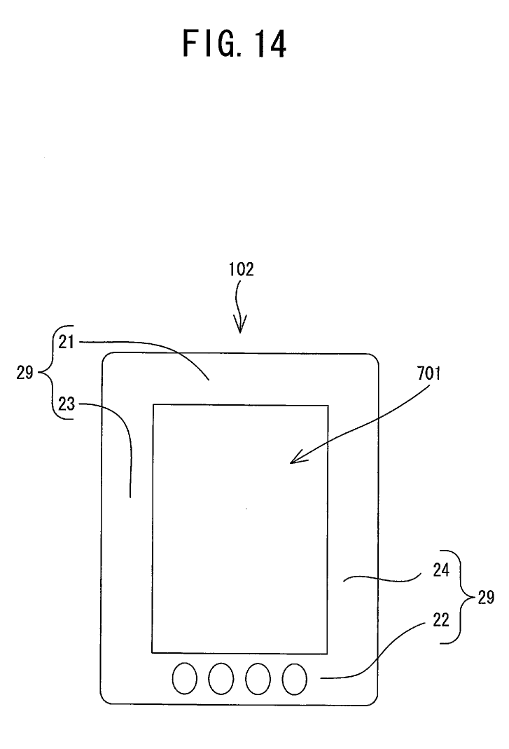

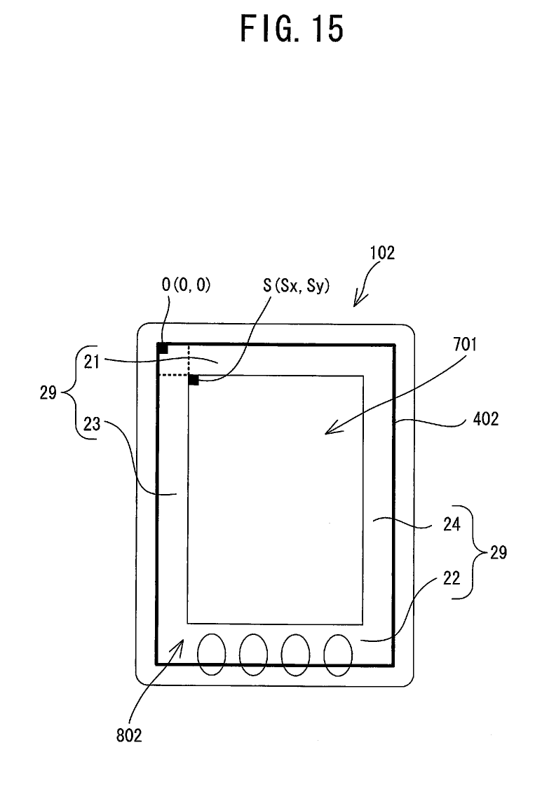

The front face of the display device 1 is not limited to the example shown in FIG. 1. For example, as shown in FIG. 12, a display device 101 may have a bottom bezel area 22 that is elongated vertically. In another example, as shown in FIG. 14, a display device 102 may have a wide bezel area 29. In the example shown in FIG. 12, the ratio of BOTTOM to the display-capable area 701 is increased, while in the example shown in FIG. 14, the respective ratios of TOP, BOTTOM, LEFT, and RIGHT to the display-capable area 701 are increased Thus, in a case where the width of at least a part of the bezel area 29 is wide, the width of at least a part of the bezel area 29 may be revised to be narrower. Subsequently, a virtual area (e.g., an area 801 within a bold frame 401 in FIG. 13, an area 802 within a bold frame 402 in FIG. 15) is posited, and the rate of enlargement, the resolution, and the reference coordinates are computed.

The revision of TOP, BOTTOM, LEFT, and RIGHT for the purpose of positing the virtual areas 801 and 802 with the narrower bezel area 29 is explained. Whether the bezel area 29 is wide or not is determined by computing a ratio (hereinafter referred to as the “comparison ratio”) for each of the widths TOP, BOTTOM, LEFT, and RIGHT in relation to the display-capable area 701, then comparing the computed comparison ratio to a predetermined threshold value (thr1). In the present embodiment, for example, thr1 is set to 0.1. In a case where the comparison ratio is greater than the threshold value (thr1), the value of the corresponding width, that is, TOP, BOTTOM, LEFT, or RIGHT, is revised to equal (W_panel)×(ratio_thr). Ratio_thr is a revision ratio. In the example shown in FIGS. 12 and 13, the value of BOTTOM is revised. In the example shown in FIGS. 14 and 15, the values of TOP, BOTTOM LEFT, and RIGHT are revised.

Taking the value of LEFT as an example, LEFT_bezel_ratio, the comparison ratio for LEFT, is computed using the equation LEFT_bezel_ratio=(LEFT)/(W_panel). If LEFT_bezel_ratio is greater than thr1, the value of LEFT is treated as too large (the width of the left bezel area 23 is wide), and the value of LEFT is revised. The revision method is to multiply W_panel by the revision ratio (ratio_thr) and make the computed value the value of LEFT. The revision ratio (ratio_thr) may be 0.1, for example. In this case, the value of LEFT becomes one-tenth of the width of the display-capable area 701. The comparison ratios for the other bezel areas are computed in the same manner. Accordingly, RIGHT_bezel_ratio, the comparison ratio for RIGHT, is computed using the equation RIGHT_bezel_ratio=(RIGHT)/(W_panel). TOP_bezel_ratio, the comparison ratio for TOP, is computed using the equation TOP_bezel_ratio=(TOP)/(W_panel). BOTTOM_bezel_ratio, the comparison ratio for BOTTOM, is computed using the equation BOTTOM_bezel_ratio=(BOTTOM)/(W_panel). Each of the computed comparison ratios is compared to thr1. If any of the comparison ratios is larger than thr1, the value of the width of the corresponding part of the bezel area 29 is computed by multiplying W_panel by ratio_thr.

As described above, in a case where the value of the width of the bezel area 29 is not appropriate, after the value is revised, the rate of enlargement is computed, after which the resolution and the reference coordinates are computed.

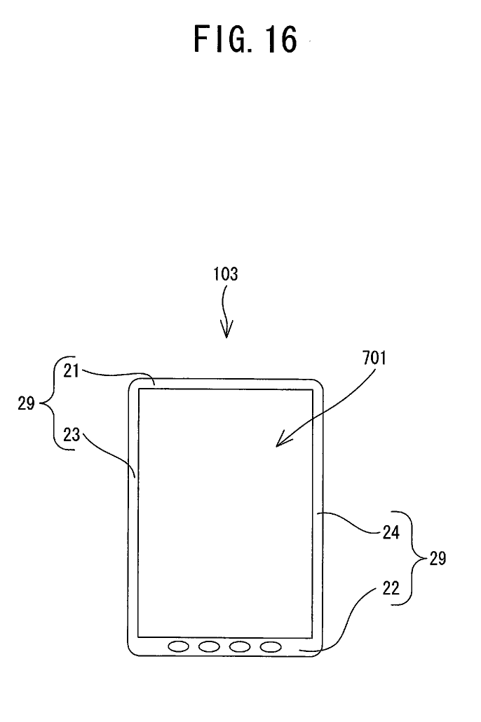

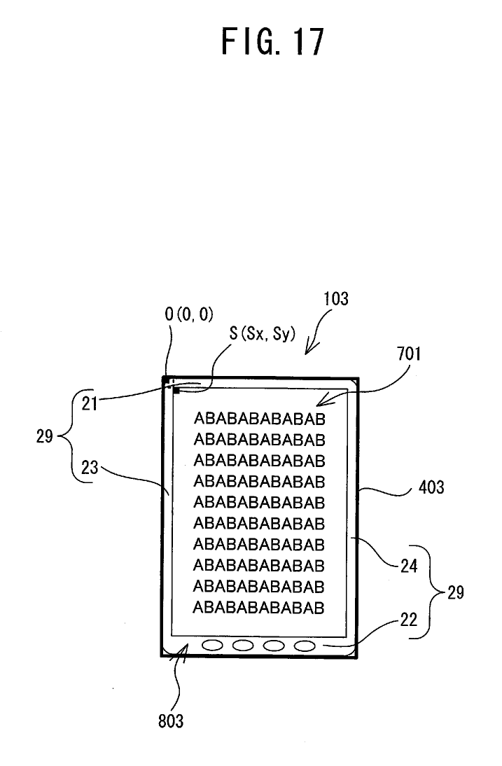

In the case of a display device 103 in which the width of a bezel area 29 is narrow, as shown in FIG. 16, the resolution and the reference coordinates may be computed by the method described above. Thus, even when the width of the bezel area 29 is narrow, the entire front face of the display device 1 is made to look like a paper page on which the content is printed, as shown in FIG. 17.

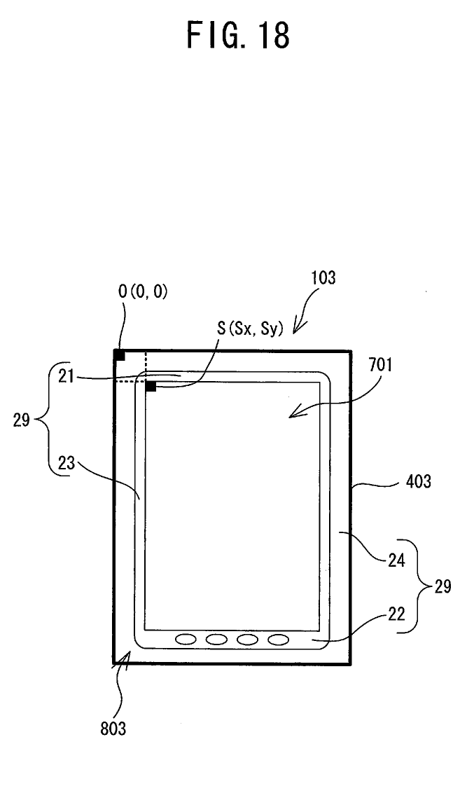

In the case of the display device 103 in which the width of the bezel area 29 is narrow, as shown in FIG. 16, the width of the bezel area 29 may be revised to be wider. Subsequently, a virtual area (e.g., an area 803 within a bold frame 403 in FIG. 18) may be posited, and the rate of enlargement, the resolution, and the reference coordinates may be computed. In this case, the revision of TOP, BOTTOM, LEFT, and RIGHT for the purpose of positing the virtual area 803 with the wider bezel area 29 is explained Whether the bezel area 29 is narrow or not is determined by computing a comparison ratio for each of the widths TOP, BOTTOM, LEFT, and RIGHT, then comparing the computed comparison ratio to a predetermined threshold value (thr2). In the present embodiment, for example, thr2 is set to 0.1. For the bezel area 29 for which the comparison ratio is less than the thr2, the value of the width of the bezel area 29 is revised to equal (W_panel)×(ratio_thr).

Taking the value of LEFT as an example, LEFT_bezel_ratio, the comparison ratio for LEFT, is computed using the equation LEFT_bezel_ratio=(LEFT)/(W_panel). If LEFT_bezel_ratio is less than thr2, the value of LEFT is treated as too small (i.e., the width of the left bezel area 23 is narrow), and the value of LEFT is revised The revision method is to multiply W_panel by the revision ratio (ratio_thr) and make the computed value the value of LEFT. The revision ratio (ratio_thr) may be 0.1, for example. In this case, the value of LEFT becomes one-tenth of the width of the display-capable area 701. The comparison ratios for the other bezel areas are computed in the same manner, using the equation RIGHT_bezel_ratio=(RIGHT)/(W_panel) for RIGHT, the equation TOP_bezel_ratio=(TOP)/(W_panel) for TOP, and the equation BOTTOM_bezel_ratio=(BOTTOM)/(W_panel) for BOTTOM. Each of the computed comparison ratios is compared to thr2. If any one of the comparison ratios is less than thr2, the value of the width of the corresponding part of the bezel area 29 is computed by multiplying W_panel by ratio_thr.

In the above examples, the threshold values (thr1, thr2) and the revision ratio (ratio_thr) are each set to 0.1, but thr1, thr2, and ratio_thr are not limited to that value. Thr1, thr2, and ratio_thr may also each be set to a different value, provided that the relationship that thr1 is less than or equal to ratio_thr and ratio_thr is less than or equal to thr2 (thr1≦ratio_thr≦thr2) is maintained. The value of ratio_thr for TOP and BOTTOM may also be different from the value of ratio_thr for LEFT and RIGHT. A different value of ratio_thr may also be set for each of TOP, BOTTOM, LEFT, and RIGHT. A different value of ratio_thr may also be determined for each of TOP, BOTTOM LEFT, and RIGHT based on the values for the margins that are set for the content If the margins that are set for the content are all five percent of the page width, ratio_thr may be any value that is at least 0.05, but not too much greater than 0.05. In this case, ratio_thr may be 0.05, 0.06, or 0.1, for example.

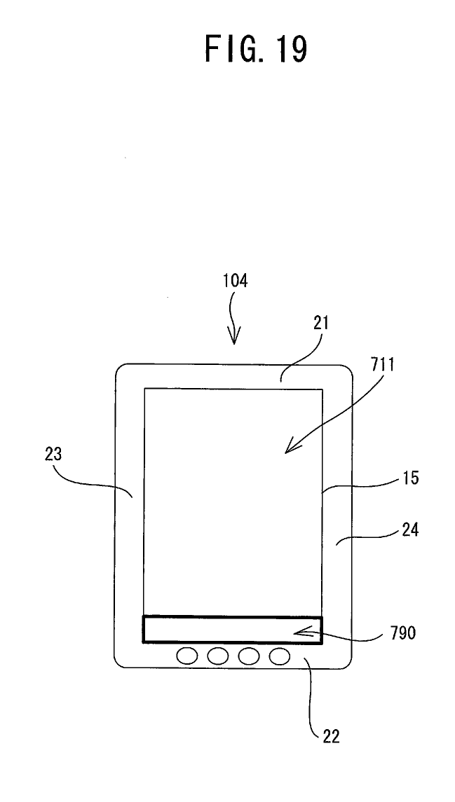

FIG. 19 shows a display device 104 in which an indicator portion 790 is provided. The indicator portion 790 may display information that is related to the content that is being displayed, such as a file name, a file creation date, and a number of pages. The indicator portion 790 may also display information that is not related to the content that is being displayed, such as a current date and time. When the indicator portion 790 is provided, the display-capable area is not the entire area of the display panel 15, but an area 711 that is the entire area of the display panel 15 exclusive of the indicator portion 790. When the indicator portion 790 is at the bottom of the display panel 15, as shown in FIG. 19, the number of pixels horizontally (X_res) in the display-capable area 711 is the number of pixels that are arranged in the horizontal direction in the display panel 15. Nevertheless, the number of pixels vertically (Y_res) in the display-capable area 711 is the number of pixels in the vertical direction in the display panel 15 minus the number of pixels in the vertical direction in the indicator portion 790. The width (W_panel) of the display-capable area 711 is the same as the width of the display panel 15, but the value that is used for the height (H_panel) is the height of the display panel 15 minus the height of the indicator portion 790.

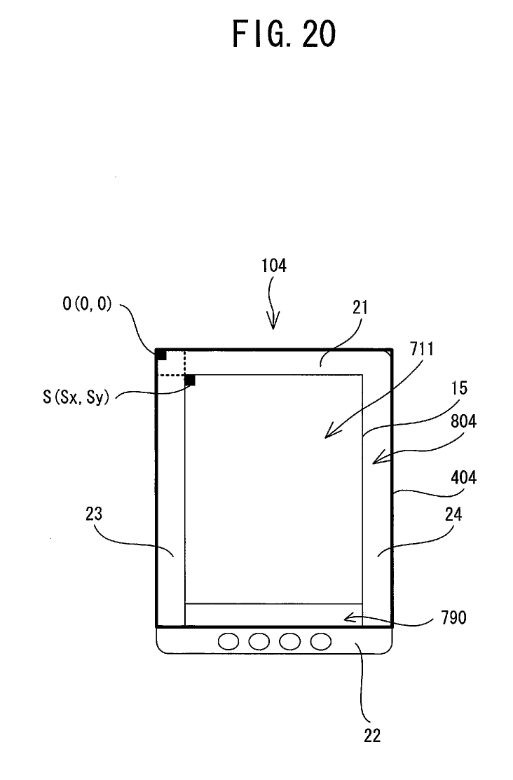

In this case as well, as shown in FIG. 20, a virtual area (e.g., an area 804 within a bold frame 404 in FIG. 20) is posited, and the rate of enlargement, the resolution, and the reference coordinates are computed by the method described above. Further, as shown in FIGS. 12 to 18, the rate of enlargement, the resolution, and the reference coordinates may be computed by the method described above after the width of the bezel area 29 is assessed and the width is revised.

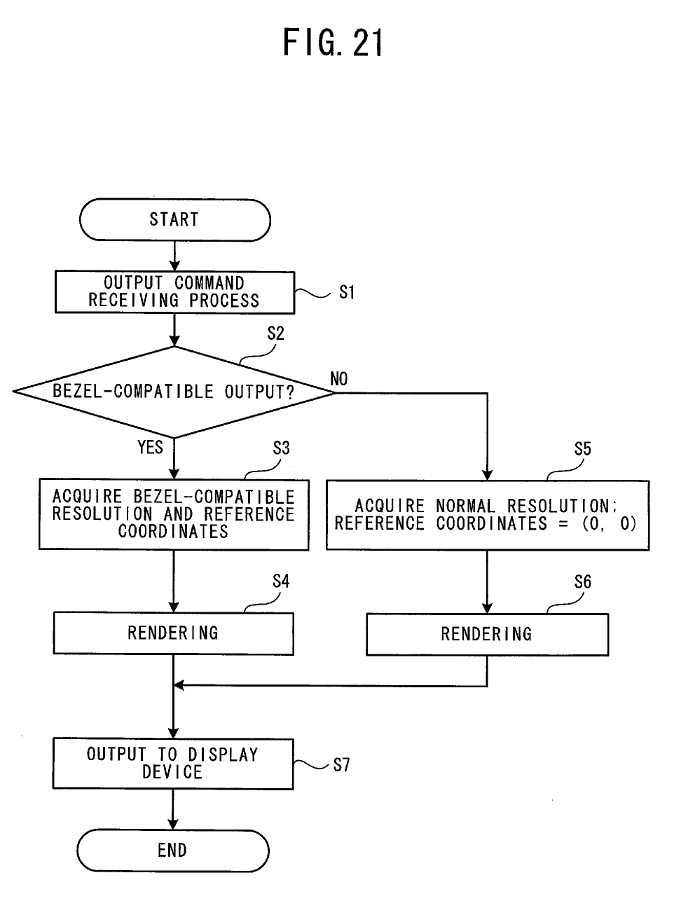

Processing by the display device driver after the user executes the output command is explained with reference to the flowchart in FIG. 21. The processing shown in FIG. 21 is performed in a case where the display driver program receives the output command through the GDI 42 when the user launches an application in the PC 3, designates a data file, designates the display device 1 as the output destination, and executes the output command.

As shown in FIG. 21, first an output command receiving process is performed (step S1). At this step, the output command is stored in a specified storage area in the RAM 32. Then a determination is made, based on information that is stored in the RAM 32, as to whether or not the output command is for bezel-compatible output (step S2). If the output command is not for bezel-compatible output (NO at step S2), the output command is for normal output, so the resolution for the page size specified in the output command is read out from the normal resolution storage area 3312, and the reference coordinates are set to (0, 0) (step S5). Next, rendering is performed at the read out resolution (step S6). Specifically, the raster data for the data that is included in the output command is created at the normal resolution. All of the pixels in the created raster data are used Next, the created raster data is output to the display device 1 (step S7), and the processing ends.

If the output command is for bezel-compatible output (YES at step S2), the resolution for the page size specified in the output command is read out from the bezel resolution storage area 3313, and the reference coordinates are read out from the reference coordinates storage area 3314 (step S3). Next, rendering is performed at the read out resolution (step S4). Specifically, the raster data for the data that is included in the output command is created at the bezel-compatible resolution. In the present embodiment, the aspect ratio of the display-capable area 701 matches the aspect ratio of the page, so the number of pixels in the raster data created for the entire page matches the number of pixels in the virtual area 800. Accordingly, the page can be placed over the entire virtual area 800. Thus, the position of the reference coordinates in the virtual area 800 corresponds to the same position in the raster data for the entire page. Therefore, only the portion of a rectangular area is used in the created raster data The rectangular area is specified by the number of pixels horizontally (X_res) in the display-capable area 701 from the reference coordinates to the right, and the number of pixels vertically (Y_res) in the display-capable area 701 from the reference coordinates downward. Any other pixels are deleted. Next, the created raster data is output to the display device 1 (step S7), and the processing ends.

As explained above, the raster data may be created using the bezel-compatible resolution and reference coordinates that are computed in advance to match the page size and the display device. Therefore, it is possible to display the content with the display-capable area 701 enlarged to the entire front face of the display device 1. Accordingly, the entire front face of the display device 1 may look like a paper page on which the content is printed, without the bezel area 29 being made to look like a superfluous margin Therefore, an easily viewable output without too large a margin may be provided to the user.

A raster data creation device and a raster data creation program according to the present disclosure are not limited the embodiment described above. Various modifications may obviously occur insofar as the modifications are within the scope of the present disclosure. In embodiments described above, the raster data is created (steps S4 and S6 in FIG. 21) by the display device driver 43, and the created raster data is transmitted to the display device 1 (step S7 in FIG. 21). Nevertheless, the creation of the raster data may also be performed by the display device 1. For example, a case is considered in which information in a data file that is stored in the memory card 19 is displayed on the display panel 15. In this case, when the output command is executed with respect to the display device 1, the processing at steps S2 to S6 in FIG. 21 is performed by the CPU 10. At a step that is equivalent to step S7, the command that outputs the created raster data to the display panel 15 is executed with respect to the display controller 14.

In the embodiment described above, when the user executes the output command in the PC 3 or when the user specifies the setting of the display device driver, the raster data creation method is selected, and the raster data is created according to the selected creation method. Nevertheless, the raster data also may be created by the creation methods for both normal output and bezel-compatible output and then transmitted to the display device 1. The user then may switch between normal output and bezel-compatible output by operating the display device 1.

In the embodiment described above, the aspect ratio of the size of the display panel 15 is the same as the aspect ratio for A-series paper sizes, so that the aspect ratio of the page is also the same. Accordingly, the page may be placed over the entire virtual area 800, and the position of the reference coordinates in the virtual area 800 corresponds to the same position of the raster data for the entire page. However, the aspect ratio of the page may not match the aspect ratio of the display panel 15. In that case, the page may be placed in the center of the virtual area 800 instead of being placed over the entire virtual area 800.

In embodiments described above, the reference point is a point in the upper left corner of the display-capable area 701, but the reference point is not limited to this example. The reference point also may be any fixed point that may be used as a reference for specifying a pixel in a display-capable area of a display device. For example, the reference point may be a point in one of the lower left corner, the upper right corner, the lower right corner, and top center of the display-capable area The reference point also may be a point that serves as a center of gravity for the display-capable area When the reference point is a point in the lower right corner of the display-capable area, RIGHT and BOTTOM are used in the computation of the starting point S (Sx, Sy).

While the invention has been described in connection with various exemplary structures and illustrative embodiments, it will be understood by those skilled in the art that other variations and modifications of the structures and embodiments described above may be made without departing from the scope of the invention Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A raster data creation device that creates raster data for displaying content, the raster data creation device comprising:
an electronic data acquisition unit that acquires electronic data of content to be displayed on a display unit provided on a front face of a display device;
a resolution storage unit that stores a first resolution computed based on a first number of pixels and an output size of the electronic data, the first number of pixels being disposed in a virtual area at a pixel density of a display-capable area, the display-capable area being an area capable of displaying the electronic data in the display unit, the virtual area being determined based on the display-capable area and on an area of the front face of the display device;
a reference coordinates storage unit that stores reference coordinates, the reference coordinates being set within the virtual area and corresponding to a reference point set within the display-capable area; and
a first creation unit that creates a first raster data from the electronic data acquired by the electronic data acquisition unit at the first resolution stored in the resolution storage unit based on the reference coordinates and on a second number of pixels disposed in the display-capable area, the first raster data being raster data of a portion within the virtual area and corresponding to the display-capable area.

2. The raster data creation device according to claim 1, further comprising:
a second creation unit that creates a second raster data from the electronic data at a second resolution, the second resolution being computed based on the second number of pixels disposed in the display-capable area and on the output size of the electronic data; and
a creation method receiving unit that receives a command for one of the first creation unit to create the first raster data and the second creation unit to create the second raster data, wherein
one of the first creation unit and the second creation unit respectively creates one of the first raster data and the second raster data in accordance with the command received by the creation method receiving unit.

3. A computer-readable medium having computer readable instructions stored thereon that create raster data for displaying content for execution by a controller to perform a method comprising the steps of:
acquiring electronic data of content to be displayed on a display unit provided on a front face of a display device; and
creating a first raster data from the electronic data acquired in the acquiring step at a first resolution, based on reference coordinates and on a first number of pixels disposed in a display-capable area, the display-capable area being an area capable of displaying the electronic data in the display unit, the first raster data being raster data of a portion being within a virtual area and corresponding to the display-capable area, the first resolution being computed based on a second number of pixels and on an output size of the electronic data and stored in advance, the virtual area being determined based on the display-capable area and on an area of the front face of the display device, the reference coordinates being coordinates set within the virtual area and corresponding to a reference point set within the display-capable area, and the second number of pixels being disposed in the virtual area at a pixel density of the display-capable area.

4. The computer-readable medium according to claim 3, wherein the method further comprises the steps of:
creating a second raster data from the electronic data at a second resolution, the second resolution being computed based on the first number of pixels disposed in the display-capable area and on the output size of the electronic data; and
receiving a command to create one of the first raster data and the second raster data, wherein one of the first raster data and the second raster data is created in accordance with the received command.

5. A display device comprising a raster data creation device that creates raster data for displaying content, the raster data creation device comprising:
an electronic data acquisition unit that acquires electronic data of content to be displayed on a display unit provided on a front face of a display device;
a resolution storage unit that stores a first resolution computed based on a first number of pixels and an output size of the electronic data, the first number of pixels being disposed in a virtual area at a pixel density of a display-capable area, the display-capable area being an area capable of displaying the electronic data in the display unit, the virtual area being determined based on the display-capable area and on an area of the front face of the display device;
a reference coordinates storage unit that stores reference coordinates, the reference coordinates being set within the virtual area and corresponding to a reference point set within the display-capable area; and
a first creation unit that creates a first raster data from the electronic data acquired by the electronic data acquisition unit at the first resolution stored in the resolution storage unit based on the reference coordinates and on a second number of pixels disposed in the display-capable area, the first raster data being raster data of a portion within the virtual area and corresponding to the display-capable area.

6. The display device according to claim 5, wherein the raster data creation device further comprises:
a second creation unit that creates a second raster data from the electronic data at a second resolution, the second resolution being computed based on the second number of pixels disposed in the display-capable area and on the output size of the electronic data; and
a creation method receiving unit that receives a command for one of the first creation unit to create the first raster data and the second creation unit to create the second raster data; and
one of the first creation unit and the second creation unit respectively creates one of the first raster data and the second raster data in accordance with the command received by the creation method receiving unit.
